(19) United States
(12) Patent Application Publication
(10) Pub. No.: US 2026/0085798 A1
(43) Pub. Date: Mar. 26, 2026

(54) ENHANCED CONTRAST FACE PLATE SYSTEM, KIT, AND METHOD

(71) Applicants: Natalie Wallace, La Mesa, CA (US); Bret Tollgaard, La Mesa, CA (US)

(72) Inventors: Natalie Wallace, La Mesa, CA (US); Bret Tollgaard, La Mesa, CA (US)

(21) Appl. No.: 19/409,889

(22) Filed: Dec. 5, 2025

Related U.S. Application Data
(63) Continuation-in-part of application No. 19/032,196, filed on Jan. 20, 2025.
Application No. 19/032,196 is a continuation of application No. 18/355,457, filed on Jul. 20, 2023, now Pat. No. 12,215,833.
(60) Provisional application No. 63/390,771, filed on Jul. 20, 2022.

(51) Int. Cl. F21K 9/275; F21Y 105/18; H01R 13/514; H01R 13/717

(52) U.S. Cl. CPC F21K 9/275; H01R 13/514; H01R 13/717; F21Y 2105/18

(57) ABSTRACT

The present disclosure provides an overlay for a face plate coupled to an electrical device. The overlay includes an overlay body having an opening configured to provide access to the electrical device. The overlay body is configured to be removably coupled to a first portion of the face plate to create a first contrast with a second portion of the face plate. The overlay body can be configured to be removably coupled to an entirety of the face plate where the overlay body can include a first zone and a second zone. The first contrast can be created between a difference in color, lighting, or texture of the first zone and the second zone. The overlay body can be removably coupled to a wall surrounding an outer perimeter of the face plate to create the first contrast with the face plate. The first contrast can be a visual or textural.

### CROSS-REFERENCE TO RELATED APPLICATIONS

This application is a continuation-in-part of Continuation Application Ser. No. 19/032,196, filed Jan. 20, 2025, which claims the benefit of U.S. application Ser. No. 18/355,457, filed Jul. 20, 2023, which claims the benefit of U.S. Provisional Application No. 63/390,771, filed on Jul. 20, 2022. The entire disclosures of the above applications are incorporated herein by reference.

### FIELD

The present technology relates to face plates and, more particularly, a system, kit, and method of making a wall mounted electrical device safer and more easily identified.

### INTRODUCTION

This section provides background information related to the present disclosure which is not necessarily prior art.

Assisted living facilities commonly provide housing for elderly and disabled individuals. Residents of assisted living facilities may have mobility issues, cognitive decline, such as dementia, or be visually impaired. These facilities allow for residents to care for themselves with assistance in certain areas of life such as laundry, bathing, meal preparation, and medical management. However, because residents are not monitored around the clock, accidents such as falls, commonly occur. Frequently, residents with low vision fall because the resident is unable to find a light switch and will continue to walk around a room until they find the light switch. Similarly, residents who have dementia fall because the resident lacks the problem-solving skills to search for the light switch and may continue to walk around in a dark room. In both these scenarios, residents find themselves walking in a dark room and can very easily trip and fall.

One method that assisted living facilities and, specifically, occupational therapists, use to reduce the risk of falling is adding contrast to a resident's room. The first areas that are contrasted are the light switches. Currently, occupational therapists address this low-contrast, low vision issue by manually outlining each face plate with black electrical tape. The addition of the black tape to the white face plate creates enough visual contrast for the resident to see the location of the light switch on the wall.

Although the above-described method is useful, it requires the occupational therapist to spend a lot of time cutting electrical tape to the dimensions of the light switch plate and applying it to every light switch in a resident's apartment and the common areas of the assisted living facility. Furthermore, it can also be helpful to add contrast to electrical outlets to allow residents to easily plug devices in, which requires an even greater time investment.

Electrical tape is used due to its ability to be easily removed. However, this feature of electrical tape can frequently result in the tape peeling away from a surface over time. Once the tape peels away or falls off completely, it needs to be replaced, and if it cannot be replaced right away, the risk of falls is increased until the contrast is reestablished. Conversely, if the electrical tape is applied to a face plate that is commonly in the sunlight, the adhesive on the tape may become sticky and leave a residue when removed. This residue needs to be cleaned before new tape can be applied. As such, using and replacing electrical tape requires additional materials, maintenance, and time.

Accordingly, there is a continuing need for a face plate that has an integral visually contrasting zones, in which the face plate provides a stable and continuous visual contrast that negates the need for maintenance and replacement. Desirably, the face plate with the visual contrast contained on, such as an overlay that is coupled onto the face plate, and within the face plate creates a visual contrast upon installation and saves time.

### SUMMARY

In concordance with the instant disclosure, a face plate that has visually contrasted zones for aiding identification of an electrical device, such as a light switch or outlet, has surprisingly been discovered.

The present disclosure provides a face plate for securing onto an electrical receptacle box. The face plate can include a plate body having an opening and a plurality of zones. The plurality of zones can surround the opening. The plurality of zones can include a first zone and the second zone. The first zone can have a visual contrast with the second zone.

The present disclosure further provides an electrical device recognition safety system. The system can include an electrical receptacle box, an electrical device, and a face plate for securing onto an electrical receptacle box. The face plate can include a plate body having an opening and a plurality of zones. The plurality of zone can surround the opening. The plurality of zones can include a first zone and the second zone. The first zone can have a visual contrast with the second zone.

The present disclosure further contemplates a method of making a wall mounted electrical device safer and more easily identified. An electrical receptacle box, an electrical device, and a face plate can be provided. The face plate can include a plate body having an opening and a plurality of zones. The plurality of zone can surround the opening. The plurality of zones can include a first zone and the second zone. The first zone can have a visual contrast with the second zone. The electrical device can be placed into the electrical receptacle box and secured within the electrical receptacle box. The face plate can be placed on the electrical receptacle box and secured to the electrical receptacle box.

The present disclosure contemplates an overlay for a face plate coupled to an electrical device. The overlay can include an overlay body having an opening configured to provide access to the electrical device. The overlay body can be configured to be removably coupled to a first portion of the face plate to create a first contrast with a second portion of the face plate. The first contrast can be a visual contrast, a textural contrast, or combinations thereof.

The present disclosure further contemplates an overlay for a face plate coupled to an electrical device where the overlay can include an overlay body having an opening configured to provide access to the electrical device. The overlay body can be configured to be removably coupled to an entirety of the face plate. The overlay body can be configured to create a first contrast. The overlay body can include a first zone and a second zone where the first zone can create the first contrast with the second zone, and vice versa.

The present disclosure further contemplates an overlay for a face plate coupled to an electrical device where the overlay can include an overlay body having an opening configured to provide access to the electrical device. The overlay body can be configured to be removably coupled to a wall surrounding an entirety of an outer perimeter of the face plate. The overlay body can be configured to create a first contrast with the face plate, exposing the entirety of the face plate and creating a border around the entirety of the face plate for enhancing the visibility of the face plate.

The present disclosure also contemplates an electrical device recognition system. The electrical device recognition system can include an electrical device, a face plate as described herein, and the overlay for the face plate. The overlay can create a first contrast with the face plate. The overlay can alternatively create the first contrast with the first zone and the second zone of the overlay body.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front elevational view of an embodiment of a face plate for a light switch having a first zone and a second zone;

FIG. 2 is a front elevational view of an embodiment of a face plate for an on/off switch having a first zone, a second zone, and a third zone;

FIG. 3 is a front elevational view of an embodiment of a face plate for an electrical receptacle;

FIG. 4 is a front elevational view of an embodiment of a face plate having an aperture;

FIG. 5 is a front elevational view of an embodiment of a face plate formed of translucent material;

FIG. 6 is an exploded view of an embodiment of an electrical device recognition safety system;

FIG. 7 is an environmental view of an embodiment of a face plate secured to a light switch and installed on a wall;

FIG. 8 is a flowchart depicting an embodiment of a method of making a wall mounted electrical device safer and more easily identified;

FIG. 9 is a front elevational view of an embodiment of an overlay for a face plate, according to an embodiment of the present disclosure;

FIG. 10 is a front elevational view of an embodiment of an overlay for a face plate, according to yet another embodiment of the present disclosure;

FIG. 11 is a front elevational view of an embodiment of an overlay for an electrical device recognition safety system, according to another embodiment of the present disclosure.

FIGS. 12-15 are front elevational views of an embodiment of an overlay for an electrical device recognition system, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

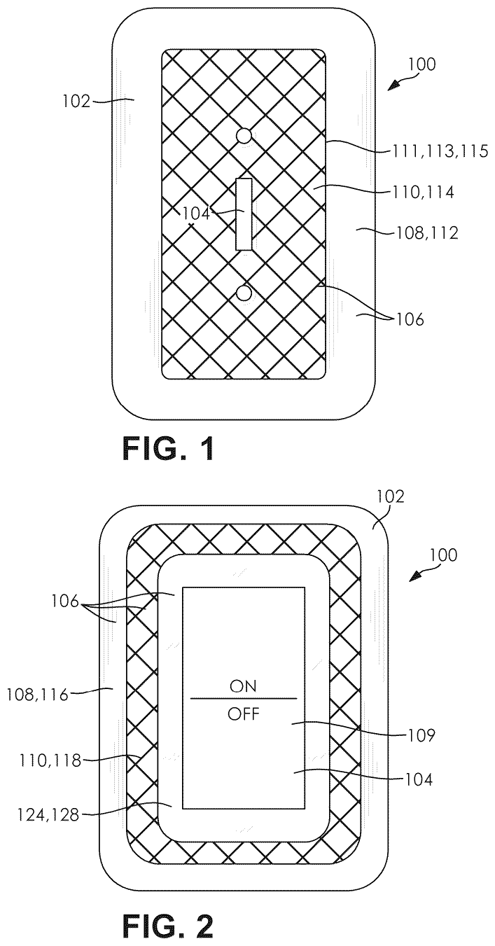

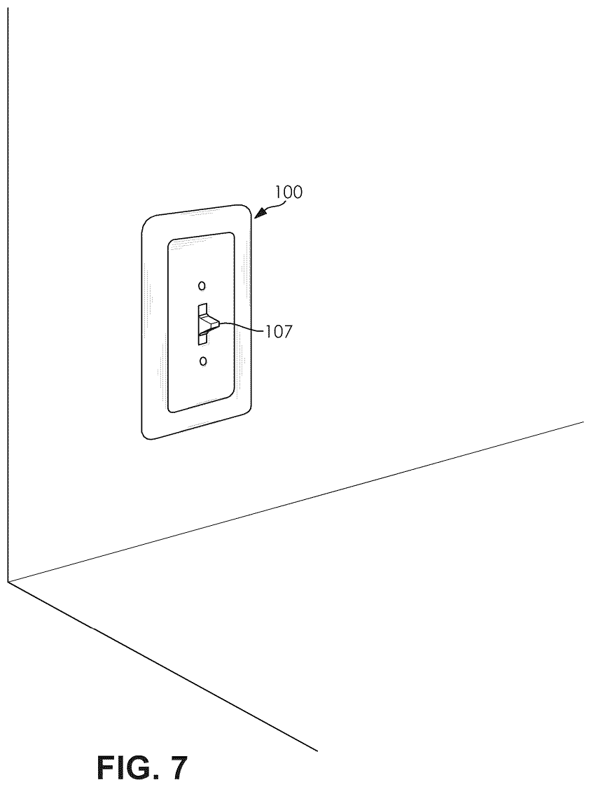

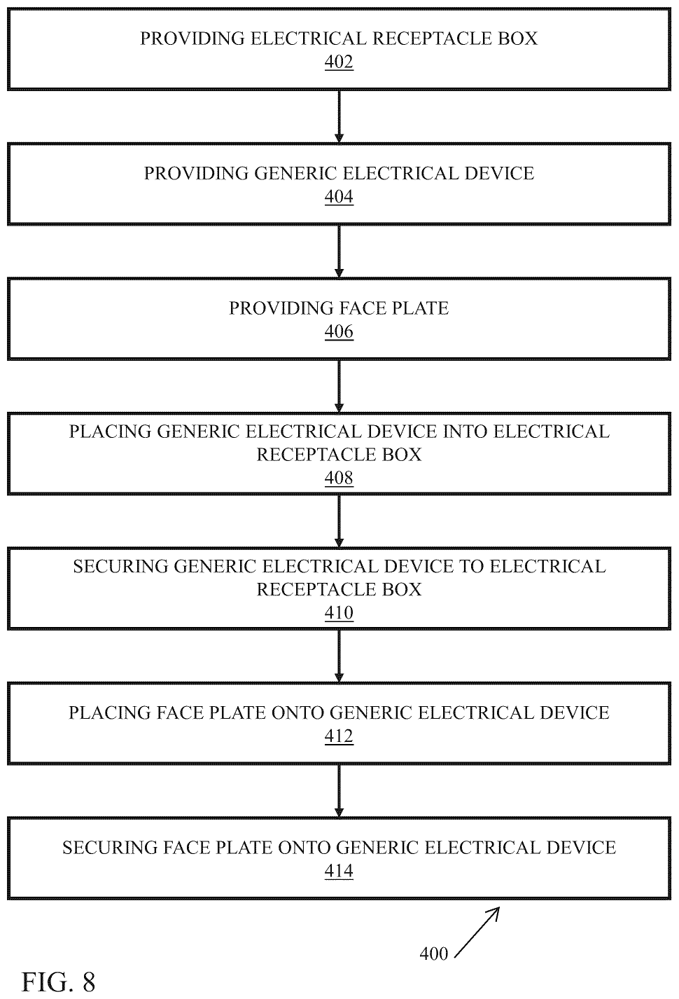

The present technology relates to a face plate 100, electrical device recognition safety system 200, an electrical device recognition safety kit 300, and method 400 of making a wall mounted electrical device safer and more easily identified, shown generically in FIGS. 1-7. Advantageously, the face plate 100 and its use on an electrical receptacle box 101 allows for a generic electric device 103, such as an electrical outlet 105, light switch 107 or on/off switch 109, to be more easily visible. As such, the face plate 100 can provide a safety advantage for the elderly and those with low vision by making the face plate more visible on a wall.

As shown in FIG. 6, the face plate 100 can be secured onto an electrical receptacle box 101. With reference to FIG. 1, the face plate 100 can include a plate body 102 having an opening 104 and a plurality of zones 106 that surround the opening 104. The opening 104 can be configured to provide access to a portion of the electrical device 103. The plurality of zones 106 can include a first zone 108 and a second zone 110. The first zone 108 can have a first visual contrast with the second zone 110. To this point, the first zone 108 and the second zone 110 can have an interface 111 where an inner perimeter 113 of the first zone 108 and an outer perimeter 115 of the second zone 110 meet and are the same in shape and dimension. The interface 111 can create a distinction between the first zone 108 and the second zone 110. The distinction can be a feature of the visual contrast. The visual contrast can be defined by an inherent value associated with the mode of contrast selected, for example, color or lighting intensity.

It should be appreciated that where the mode of visual contrast is color, the inherent value employed to define the contrast is a color contrast ratio. For example, the color contrast ratio can have a value equal to or greater than 4:1 in at least a few instances, equal to or greater than 5.5:1 in at least some instances, and equal to or greater than 7:1 in most instances. The color intensity contrast ratio can be determined by comparing the relative luminance of the lighter color to the relative luminance of the darker color.

It should also be appreciated that where the mode of visual contrast is lighting intensity, the inherent value employed to define the contrast is a lighting intensity contrast ratio. For example, the lighting intensity contrast ratio can have a value equal to or greater than 2:1 in at least a few embodiments, equal to or greater than 3:1 in at least some embodiments, and equal to or greater than 4:1 in most embodiments. The light intensity contrast ratio can be determined by comparing the lumens of the higher lighting intensity to the lumens of the lower lighting intensity.

With reference to FIG. 1-5 and as explained hereinabove, the first visual contrast between the first zone 108 and the second zone 110 can be created by a difference in color, a difference in lighting, a difference in both color and lighting, or any difference that could be selected by a skilled artisan within the scope of the present disclosure, each shown in FIGS. 1-4 where a difference in color is depicted in FIG. 1 with the first zone 108 having no crosshatching and the second zone 110 having cross hatching. For example, the first zone 108 can include a first color 112 and the second zone 110 can include a second color 114, depicted in FIG. 1 by crosshatching. The first color 112 and the second color 114 can be different such that a first visual contrast is created when the first color 112 and the second color 114 are disposed adjacent to one another on the face plate 100. A skilled artisan can select a suitable color for the first color 112 and the second color 114 such that there is contrast. Additionally, the first color 112 and the second color 114 can be selected to contrast with the color of the wall on which the face plate 100 is installed.

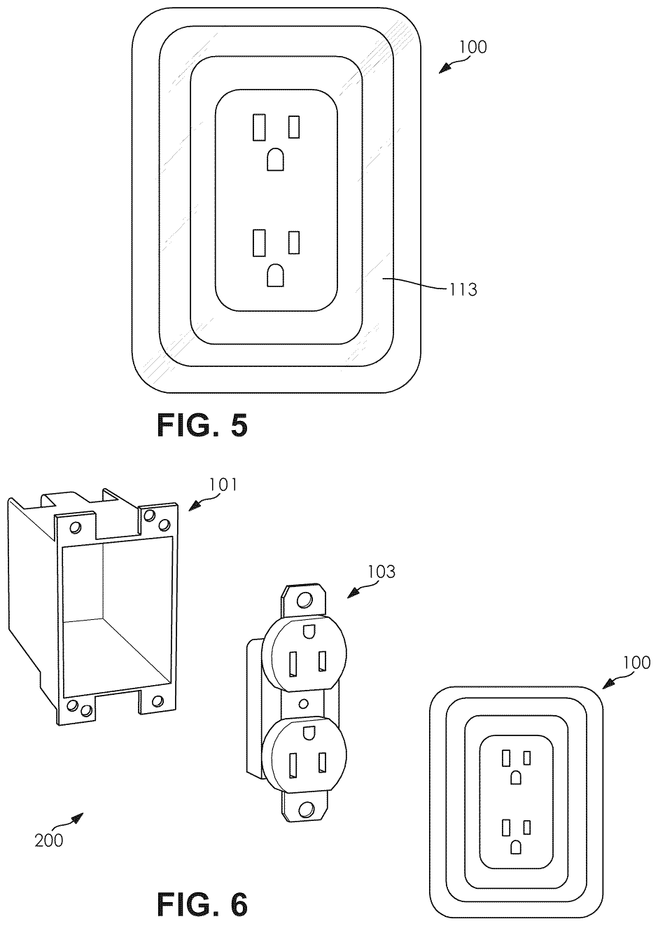

As a further example and with continued reference to FIG. 2, the first visual contrast between the first zone 108 and the second zone 110 can be created by a difference in lighting intensity, depicted with crosshatching in FIG. 2. The first zone 108 can include a first lighting intensity 116 and the second zone 110 can include a second lighting intensity 118. The first lighting intensity 116 and the second lighting intensity 118 can be different such that the first visual contrast is created when the first lighting intensity 116 and the second lighting intensity 118 are disposed adjacent to one another on the face plate 100. Where there is a visual contrast created by lighting intensity, the lighting intensity can be supplied by an emanating light source 120. As a non-limiting example, the emanating light source 120 can be an LED light. A skilled artisan can select a suitable emanating light source 120 within the scope of the present disclosure. To this point, the plate body 102 can be formed from a translucent material 113, as shown in FIG. 5, to permit light from the emanating light source 120 to pass therethrough. Alternatively, and as shown in FIG. 4, the lighting intensity created by the emanating light source 120 can pass through the plate body 102 via an aperture 122 in the plate body 102.

With continued reference to FIG. 4, the aperture 122 can be rectangular in shape. Alternatively, the aperture 122 can be circular, triangular, hexagonal, or any shape that can be confined within a perimeter of one zone of the plurality of zones 106. The aperture 122 can also be any size such that the aperture 122 is confined within the perimeter of one zone of the plurality of zones 106. A skilled artisan can select any suitable shape and size for the aperture 122 within the scope of the present disclosure. Additionally, the face plate 100 can include several apertures 122 within one zone of the plurality of zones 106. Further, the first zone 108, the second zone 110, and any additional zone within the plurality of zones 106 can all include apertures 122 configured to allow for light created by the emanating light source 120 to pass through the plate body 102.

Alternatively, the lighting intensity can be supplied by a luminescent material disposed on or in the plate body 102. For example, the first zone 108 and the second zone 110 can be formed of the luminescent material with the concentration of the luminescent material in the first zone 108 differing from the concentration of the luminescent material in the second zone 110 to create visual contrast. In an alternative embodiment, the luminescent material can be disposed on the surface of the first zone 108 and the second zone 110 in different concentrations to create the first visual contrast. A skilled artisan can select a suitable concentration of luminescent material for the first zone 108 and the second zone 110 within the scope of the present disclosure. It should also be appreciated that the luminescence can be, but is not limited to, fluorescence, photoluminescence, electroluminescence, and phosphorescence. A skilled artisan can select a suitable form of luminescence within the scope of the present disclosure.

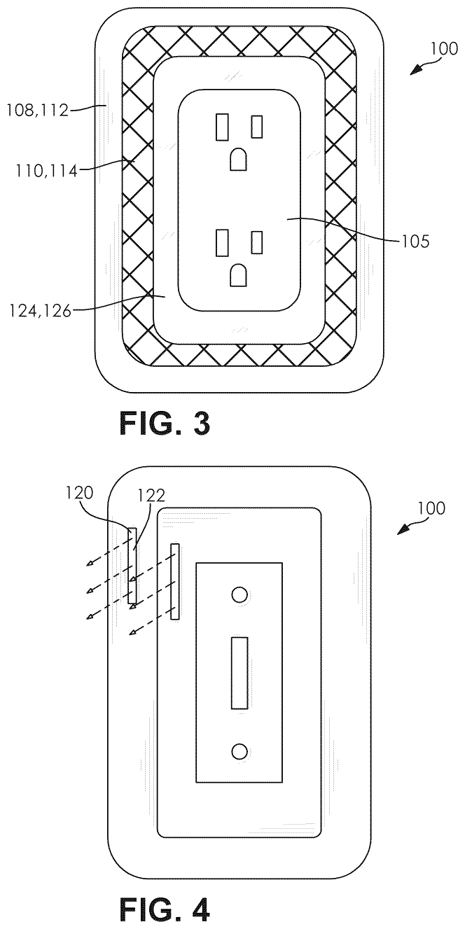

As shown in FIGS. 2-3, the plurality of zones 106 can include a third zone 124. The third zone 124 can have a second visual contrast with the second zone 110. The visual difference between the second zone 110 and the third zone 124 can be created by a difference in color where the third zone 124 is a third color 126, shown in FIG. 3. In certain embodiments, the first color 112 and the third color 126 can be the same and the second color 114 can be different from the first color 112 and the third color 126, shown with crosshatching in FIG. 3.

Alternatively, the first color 112, the second color 114, and the third color 126 can all be different colors. Further, the first color 112, the second color 114, and the third color 126 can be the same color but vary in intensity or hue such that a visual contrast is created. It should be noted that the first color 112, the second color 114, and the third color 126 can be selected to contrast with the color of the wall the face plate 100 is installed upon.

As a further example, and with continued reference to FIG. 2, the visual difference between the second zone 110 and the third zone 124 can be created by a difference in lighting intensity where the third zone 124 is a third lighting intensity 128. In certain embodiments, the first lighting intensity 116 and the third lighting intensity 128 can be the same and the second lighting intensity 118 can be different from the first lighting intensity 116 and the third lighting intensity 128, shown with crosshatching in FIG. 2. Alternatively, the first lighting intensity 116, the second lighting intensity 118, and the third lighting intensity 128 can all be different lighting intensities. Further, the first lighting intensity 116, the second lighting intensity 118, and the third lighting intensity 128 can be the same lighting intensity but vary in brightness, saturation, or hue temperature such that a visual contrast is created.

The face plate 100 can be any shape that fits over an electrical receptacle box 101. As non-limiting examples, the face plate 100 can be a rectangle, as shown in FIGS. 1-7, or other shapes including an “X” shape, a circle, or a triangle. A skilled artisan can select a shape for the face plate 100 within the scope of the present disclosure. Advantageously, the shape of the face plate 100 can signify as an identifier as to the type of generic electric device 103 in use. As a non-limiting example, a rectangular face plate 100 could signify a light switch 107 and an oval face plate 100 could signify an electrical outlet 105. Further, the first zone 108 and the second zone 110 can be any shape such that the interface 111 between the first zone 108 and the second zone 110 are substantially the same.

The face plate 100 can be formed from any rigid material such as plastic, polyvinyl chloride (PVC), polycarbonate, nylon plastic, metal, wood, and composite material. A skilled artisan can select a suitable material for the face plate 100 within the scope of the present disclosure.

The present disclosure also contemplates an electrical device recognition safety system 200. The system 200 can include an electrical receptacle box 101, a electrical device 103, and a face plate 100 as described hereinabove. The face plate 100 can be configured to be secured over the electrical receptacle box 101. Additionally, the face plate 100 can be configured to be secured to the electrical device 103 via a fastening means such as a screw, adhesive, or a snap. Advantageously, the face plate 100 can be installed upon or secured to a standard electrical receptable box 101 or electrical device 103 to allow for the face plate 100 to be retrofit to any electrical receptacle box 101 and/or electrical device 103 that is already installed. Desirably, additional installation is not required beyond securing the face plate 100 over the electrical receptacle box 101 or to the electrical device 103.

The present disclosure contemplates an electrical device recognition safety kit. The safety kit can include a face plate 100, as described hereinabove, and a fastening means. As described above, the fastening means can be configured to secure the plate body 102 over the electrical receptacle box 101 and can include, but is not limited to, a screw, adhesive, or a snap. Advantageously, the safety kit can allow for a user to purchase the face plate 100 and fastening means to retrofit the face plate 100 onto a previously installed electrical receptacle box 101 or electrical device 103.

The present disclosure further contemplates a method 400 for making a wall mounted electrical device safer and more easily identified. In a step 402, an electrical receptable box 101 can be provided. An electrical device 103 can be provided in a step 404. The electrical device 103 can include an electrical outlet 105, a light switch 107, or an on/off switch 109, as described hereinabove. A skilled artisan can select a suitable electrical device 103 within the scope of the present disclosure. In a step 406, a face plate 100 described hereinabove can be provided. The face plate 100 can include a plate body 102 having an opening 104 and plurality of zones 106 surrounding the opening including a first zone 108 and a second zone 110. The electrical device 103 can be placed into the electrical receptacle box 101 in a step 408. In a step 410, the electrical device 103 can be secured to or within the electrical receptacle box 101. The electrical device 103 can be secured using a fastener such as a screw. The face plate 100 can be coupled or placed onto the electrical device 103 in a step 412, where the electrical device 103 can include a wall mounted electrical device. In a step 414, the face plate 100 can be secured to the electrical device 103 using a fastener such as a screw. Where the face plate is installed, the electrical device 103 has been made safer and more easily identified.

Advantageously, the face plate 100, the electrical device recognition safety system 200, the electrical device recognition safety kit 300, and the method 400 of making a wall mounted electrical device 103 safer and more easily identified described hereinabove can allow the user to easily identify where an electrical outlet 105 or light switch 107 is located on a wall. Desirably, this allows the user, particularly users with dementia or who are visually impaired, to live in a safer environment by being able to quickly and easily identify where an electrical outlet 105 or light switch 107 is located.

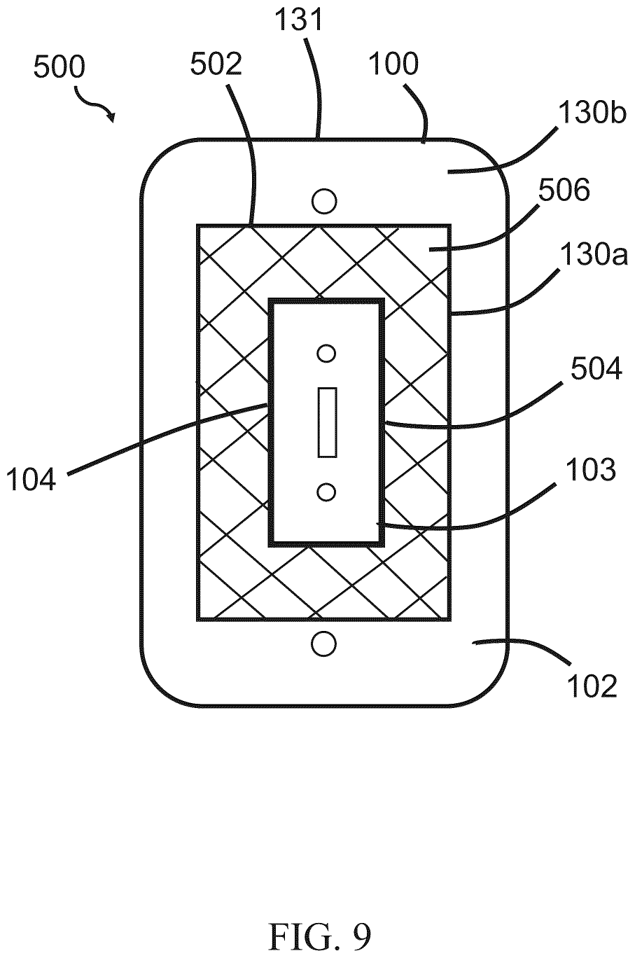

The present technology contemplates an overlay 500, with reference to FIGS. 9-15. The overlay 500 can be configured to allow users to easily identify the face plate 100 coupled to the electrical device 103. The overlay 500 can include an overlay body 502 configured to be coupled to the face plate 100. As used herein, the term “overlay” can be understood to define something laid as a covering over something else. The term “overlay” can also be a “bordering element” which can be understood to define something laid as a covering over or around something else and can include film-type coverings, clip-on frames, bezels, and/or any other element configured to cover, surround, or border a face plate 100 to create a contrast. The term “overlay” can also be understood to mean covering the surface of something. The overlay 500 can be a sticker-like material or film material configured to be removably coupled to the face plate 100. Advantageously, the overlay 500 can be removably coupled to an existing face plate 100 to allow the electrical device 103 to be easily identified without the need to modify the existing face plate 100 of the electrical device 103.

The overlay body 502 can be manufactured of vinyl. The overlay body 502 can be made of certain layers including a surface material, an adhesive, and a backing material. In particular, the surface material can include polyvinyl or polyethylene terephthalate with plasticizers, stabilizers, fillers, and colorants, as a non-limiting example. The adhesive can include nitrocellulose, polyvinyl acetate, ethylene copolymer, polyethylene, polyamides, polyesters, acrylics, and cyanoacrylates, as a non-limiting example. The backing material can include paper, plastic film, foam, or foil, as a non-limiting example. One of ordinary skill in the art can select a suitable material to manufacture the overlay 500 within the scope of the present disclosure.

The overlay 500 can be removably coupled to the face plate 100 of the electrical device 103. The face plate 100 can be a cable organizer, a light switch plate, or any face plate within the scope of the present disclosure for securing the electrical device 103 to the wall. As described herein, the electrical device 103 can be configured for the electrical receptacle box 101 and can be a generic electric device 103, such as an electrical outlet 105, light switch 107 or on/off switch 109, to be more easily visible, as described herein. The electrical device 103 can also be any electrical device configured on a wall such as an outlet, a ground fault circuit interrupter (GFCI) outlet, an arc fault circuit interrupter (AFCI) outlet, a tamper-resistant receptacle, a split circuit receptacle, a universal serial bus (USB) outlet, a smart outlet, and any other electrical device within the scope of the present disclosure. The electrical device 103 can also be a dial, a dimmer switch, as well as an emergency call alarm. The electrical device 103 can also be a thermostat, a control interface, an alarm, or any other signaling device. The overlay 500 can be configured to be removably coupled to any electrical device 103 disposed on a wall for enhancing the visibility of the electrical device 103 on the wall. One of ordinary skill in the art can configure the overlay 500 on any electrical device 103 within the scope of the present disclosure.

The overlay body 502 can include a polygonal shape. The overlay body 502 can include pointed edges or curved edges. In an alternative embodiment, the overlay body 502 can be configured in any suitable shape or a shape identical to the shape of the face plate 100. One of ordinary skill in the art can select a suitable shape to configure the overlay body 502 within the scope of the present disclosure.

The overlay body 502 can include an opening 504 configured to provide access to a portion of the electrical device 103. The overlay body 502 can be configured to be removably coupled to a first portion 130a of the face plate 100. A second portion 130b of the face plate 100 does not include the overlay body 502. It should be appreciated that the first portion 130a and the second portion 130b can define portions of the face plate 100, particularly the plate body 102, and the face plate 100 can also be made up of additional portions.

The overlay body 502 can be configured to be centrally disposed around an entirety of the opening 104 of the face plate 100 and the electrical device 103, as shown in FIG. 9. The opening 504 of the overlay body 502 can be aligned with the opening 104 of the plate body 102 of the face plate 100 for providing access to the electrical device 103. As shown in FIG. 9, the second portion 130b of the face plate 100 is configured to surround and border an entirety of the overlay body 502. In this configuration, the overlay body 502 can be configured to include dimensions that are smaller than dimensions of the face plate 100. More specifically, in a non-limiting example, the overlay body 502 can include a width between the range of 1 to 5 centimeters and a height between the range of 7 to 10 centimeters. The overlay body 502 can be configured to be smaller in dimensions than the face plate 100 in order to create the first contrast 506 between the overlay body 502 and the face plate 100. For example, the overlay body 502 can include a first height and a first width, the face plate 100 can include a second height and a second width greater than the first height and the first width, respectively. One of ordinary skill in the art can select a suitable configuration for the overlay 500 within the scope of the present disclosure.

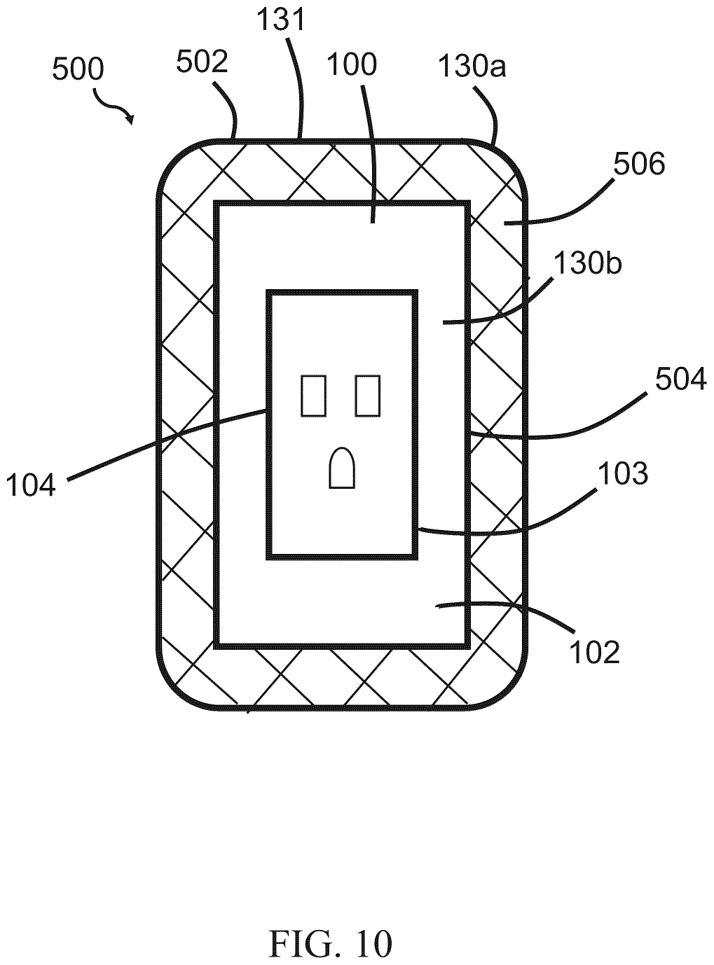

In an alternative embodiment, the overlay body 502 is configured to surround and border an entirety of the second portion 130b of the face plate 100, as shown in FIG. 10. The overlay body 502 can be disposed on the first portion 130a of the face plate 100 adjacent an outer perimeter 131 of the face plate 100 where the overlay body 502 borders and surrounds the entirety of the second portion 130b of the face plate 100. It should be understood that the outer perimeter 131 of the face plate 100 describes an outermost edge of the plate body 102 of the face plate 100. The second portion 130b of the face plate 100 can be disposed between each of the overlay body 502 and the opening 104 of the face plate 100 providing access to the portion of the electrical device 103. One of ordinary skill in the art can select a suitable configuration for the overlay body 502 within the scope of the present disclosure.

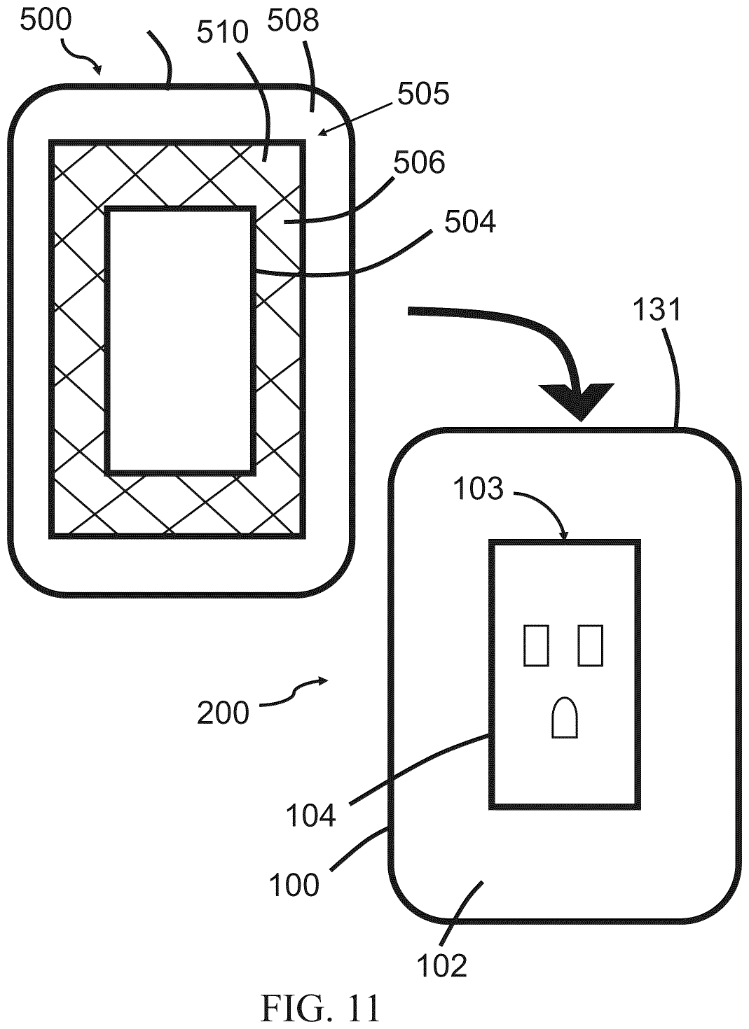

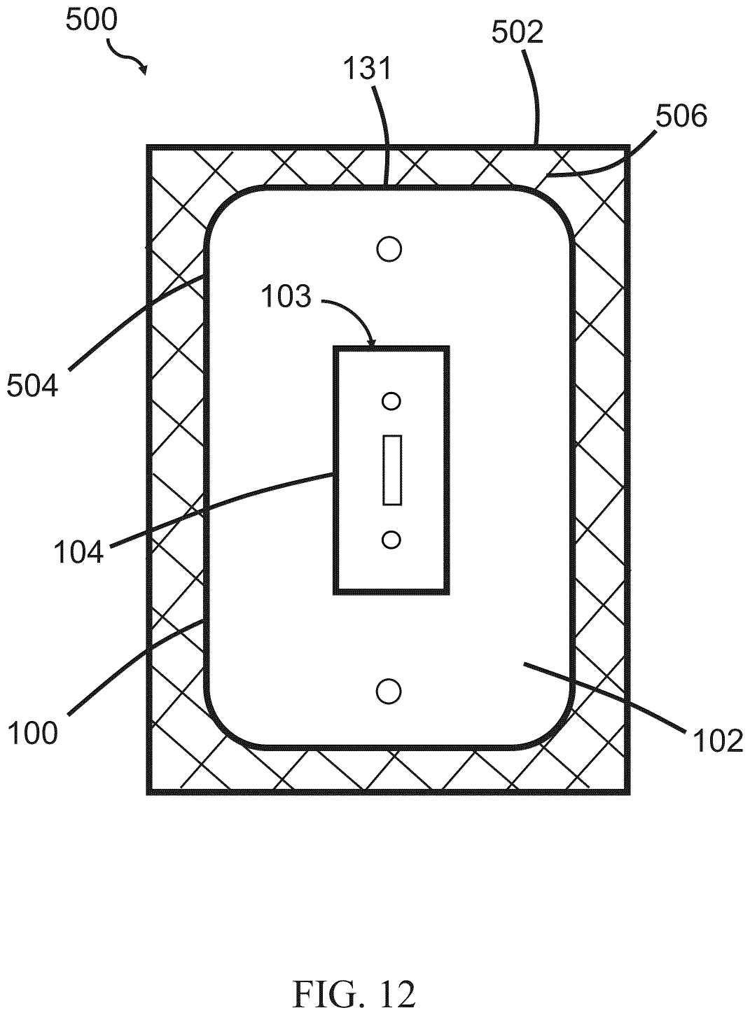

The overlay body 502 can be removably coupled to the face plate 100, particularly, the plate body 102, to create a first contrast 506. More specifically, the overlay body 502 can be configured to be removably coupled to the first portion 130a of the face plate 100 to create the first contrast 506 with the second portion 130b of the face plate 100. As used herein, the terms “contrast” can be defined as the state of being strikingly different from something else in juxtaposition or close association, or the use of opposing elements, such as colors, forms, or lines, in proximity to produce an intensified effect in visual appearance. With reference to FIGS. 9-10, the first contrast 506 is depicted with the overlay body 502 having crosshatching and the second portion 130b of the face plate 100 having no crosshatching. With reference to FIG. 11, the first contrast 506 is depicted entirely with the overlay body 502, as further described herein. With reference to FIGS. 12-15, the first contrast 506 is depicted with the overlay body 502 having crosshatching and the plate body 102 of the face plate 100 having no crosshatching.

The first contrast 506 can be a visual contrast. The visual contrast can be created by a difference in color, a difference in lighting, a difference in intensity, and combinations thereof. The first contrast 506 can be created by a difference in color where the overlay body 502 can include a first color and the second portion 130b of the face plate 100, or the plate body 102 of the face plate 100, can include a second color. As a non-limiting example, the first color of the overlay body 502 can be black and the second color of the second portion 130b of the face plate 100 can be white, or vice versa. The visual contrast can also be reflective for enhancing high-visibility of the overlay body 502, specifically during the nighttime. The reflective material can include microprisms to reflect light back to its source for making the overlay body 502 highly visible, especially in low-light conditions. One of ordinary skill in the art can select a suitable difference in color to create the visual contrast between the overlay 500 and the face plate 100 within the scope of the present disclosure.

The first contrast 506 can also be a textural contrast. As used herein, the term “textural” can be defined as relating to texture including the feel, appearance, or consistency of a surface of a substance. In the context of the overlay 500, the term “texture” can be defined as the feel of the surface of the overlay body 502. The surface of the overlay body 502 can be understood to define an outer surface of the overlay body 502. The textural contrast can include surface alterations on the outer surface of the overlay body 502 to create a textural contrast with the second portion 130b of the face plate 100, or the plate body 102 of the face plate 100. The textural contrast can alternatively include a smooth uninterrupted surface. The smooth uninterrupted surface can be matte. As used herein, the term “matte” can be defined as a dull, non-shiny, or non-glossy surface or finish. Advantageously, the matte surface can allow the user to easily identify the electrical device 103 when the overlay body 502 is removably coupled thereto. It should be appreciated that the matte surface is preferred over a glossy surface for identifying colors as the matte surface minimizes glare and reflections which allows for a clear and more accurate view of the color as well as the first contrast 506. One of ordinary skill in the art can configure the first contrast 506 in any suitable configuration including a visual, textural, or any suitable contrast or combination thereof within the scope of the present disclosure.

The overlay body 502 can also include a plurality of zones 505 including a first zone 508 and a second zone 510. The plurality of zones 505 can be configured to create the first contrast 506 on the overlay body 502, as shown in FIG. 11. More specifically, with reference to FIG. 11, the first contrast 506 is depicted with the first zone 508 having no crosshatching and the second zone 510 having crosshatching. The plurality of zones 505 can include different colors, different textures, different lighting intensities, and combinations thereof, as described herein, to create the first contrast 506 on the overlay body 502 between the first zone 508 and the second zone 510. The overlay body 502 can include at least two different colors, in a non-limiting example, where the first zone 508 can be white and the second zone 510 can be black. Alternatively, the first zone 508 can be black and the second zone 510 can be white. One of ordinary skill in the art can select a suitable first contrast 506 between the first zone 508 and the second zone 510 within the scope of the present disclosure. One of ordinary skill in the art can also configure the overlay body 502 with a third zone or at least two zones to create more than one contrast on the overlay body 502. It should be appreciated that the first contrast 506 can be created entirely by the overlay body 502 itself, as shown in FIG. 11.

The first contrast 506 can also be created with luminescent material disposed on the surface of the first zone 508 and the second zone 510 in different concentrations to create the first contrast 506. A skilled artisan can select a suitable concentration of luminescent material for the first zone 508 and the second zone 510 within the scope of the present disclosure. Alternatively, the overlay body 502 can be created with the luminescent material to create the first contrast 506 with the face plate 100 or the plate body 502 when the overlay body 502 is disposed on the face plate 100. It should also be appreciated that the luminescence can be, but is not limited to, fluorescence, photoluminescence, electroluminescence, and phosphorescence. A skilled artisan can select a suitable form of luminescence within the scope of the present disclosure.

The overlay body 502 can be configured to be removably coupled to an entirety of the face plate 100, as shown in FIG. 11. The first contrast 506 is created entirely between the first zone 508 and the second zone 510 of the overlay body 502 where the overlay body 502 is disposed on the entirety of the face plate 100. For example, the overlay body 502 can be coupled to the entirety of the plate body 102 of the face plate 100, as shown in FIG. 11, where the overlay body 502 can completely cover the plate body 102 of the face plate 100 and the opening 504 of the overlay body 502 can be aligned with the opening 104 of the electrical device 103. Desirably, this allows the user to easily couple the overlay 500 to the face plate 100 to create the first contrast 506. The overlay body 502 can be configured in dimensions that are equal to dimensions of the face plate 100 to cover the entirety of the face plate 100, as shown in FIG. 11. For example, the overlay body 502 can include the first height and the first width and the face plate 100 can include the second height and the second width, which are equal to one another.

The overlay body 502 can also be configured to be positioned adjacent an outer perimeter 131 of the face plate 100, as shown in FIGS. 12-15. The overlay body 502 can be removably coupled to the wall surrounding the outer perimeter 131 of the face plate 100. The overlay body 502 can border the entire outer perimeter 131 of the plate body 102 of the face plate 100. The outer perimeter 131 of the face plate 100 can be entirely surrounded by the overlay body 502 to create the first contrast 506 between the overlay body 502 and the face plate 100. It should be appreciated that the outer perimeter 131 can be understood to mean the outermost boundary or edge of the face plate 100.

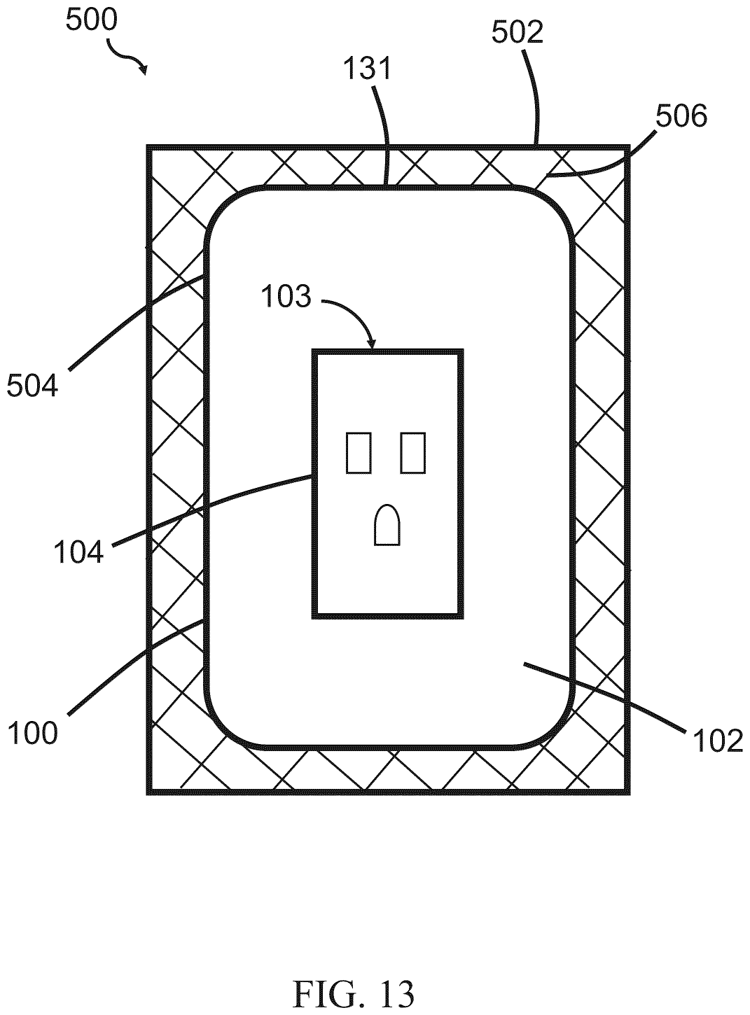

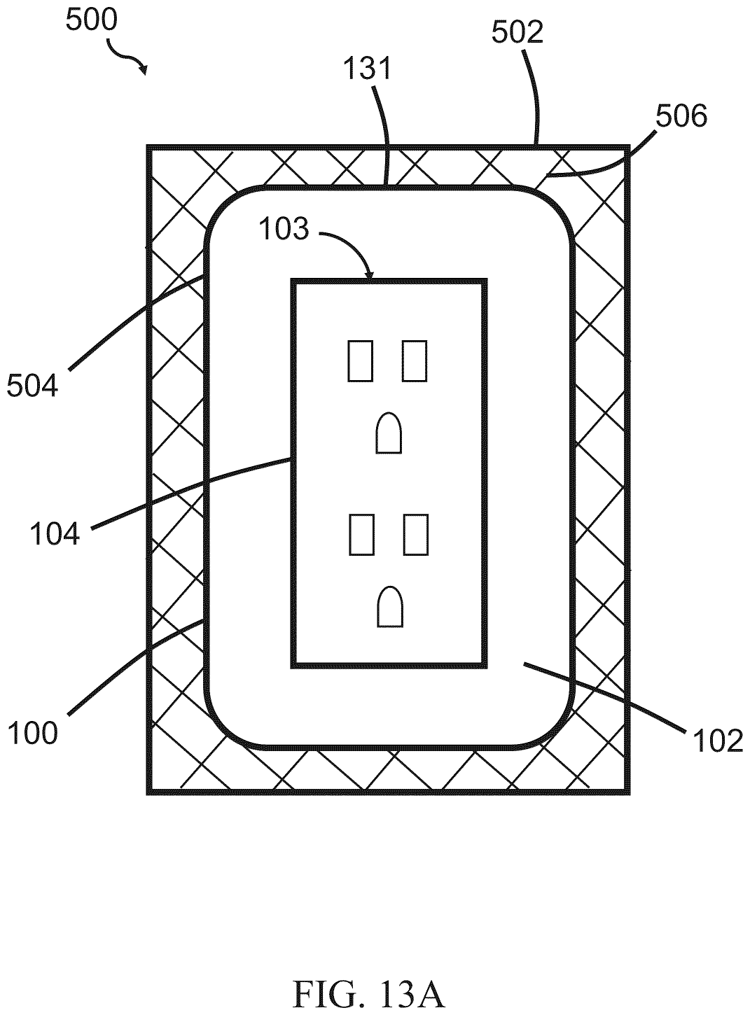

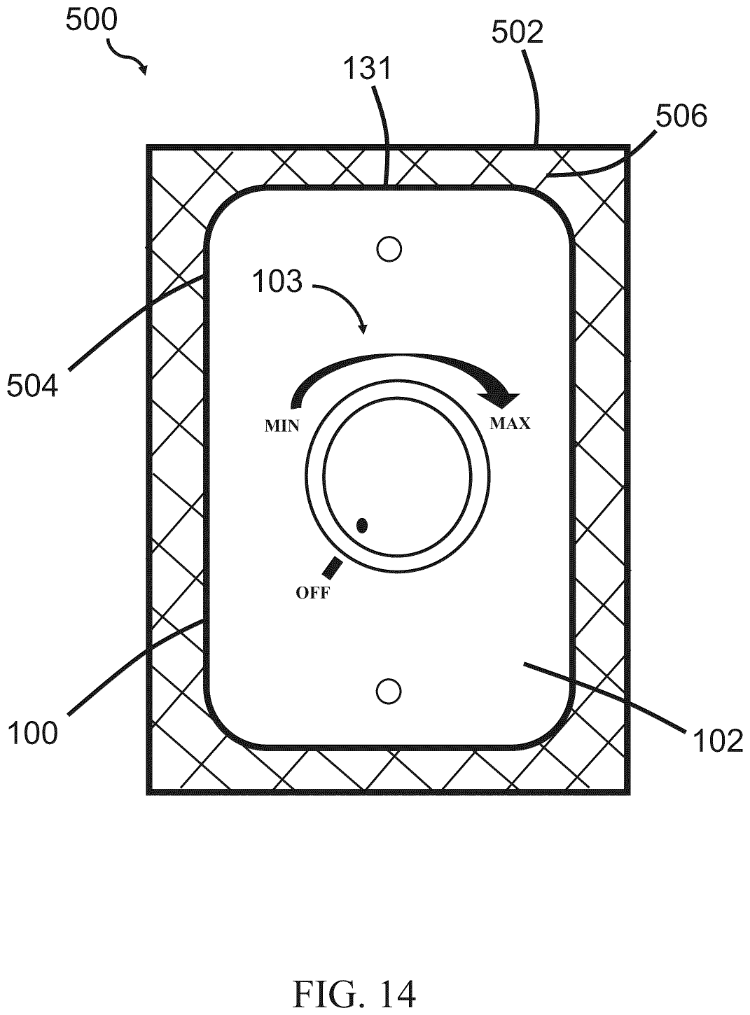

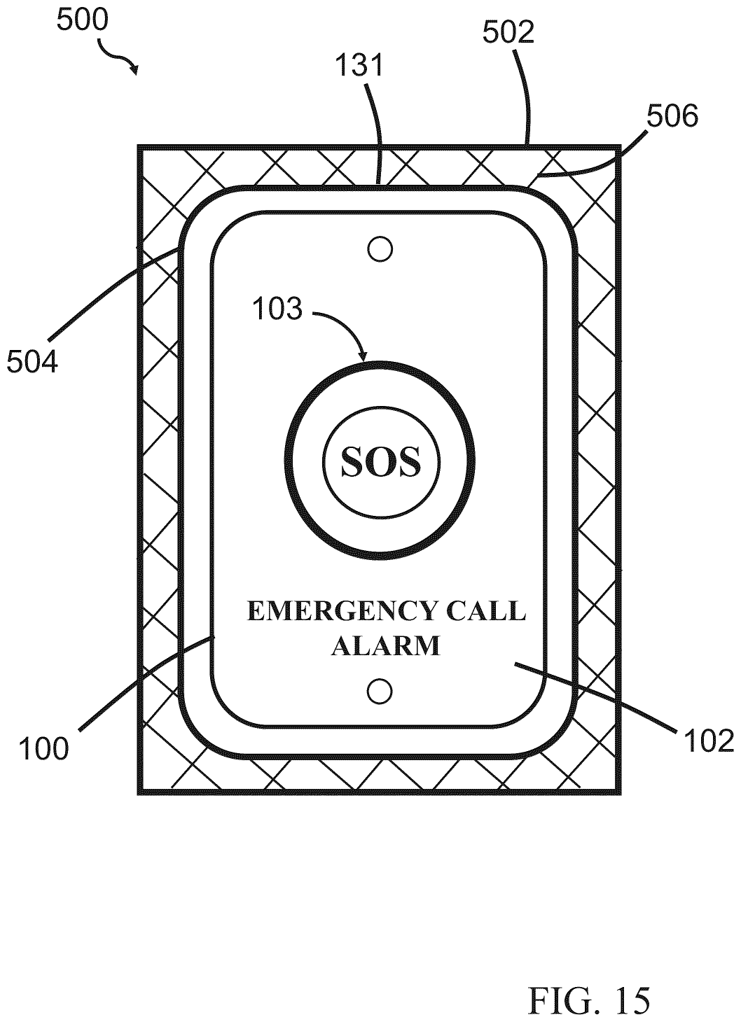

With reference to FIGS. 12-15, the overlay body 502 can be removably coupled to the wall, instead of the plate body 102 or the face plate 100 itself. Rather, the overlay body 502 can be removably coupled to the wall adjacent the outer perimeter 131 of the face plate 100 to create the first contrast 506. The overlay body 502 can be a first color, for example, and the plate body 102 of the face plate 100 can be a second color, creating the first contrast 506 between the overlay body 502 and the plate body 102 of the face plate 100. Desirably, the overlay body 502 can be disposed adjacent the outer perimeter 131 of the face plate 100 to expose the entirety of the face plate 100, as shown in FIGS. 12-15. The face plate 100 can be configured over the electrical device 103 such as a light switch as shown in FIG. 12, a single electrical receptacle or electrical outlet as shown in FIG. 13, a double electrical receptacle as shown in FIG. 13A, a dial as shown in FIG. 14, or an emergency call alarm as shown in FIG. 15. With reference to FIGS. 12-15, the overlay body 502 can be configured to include dimensions that are larger or greater than dimensions of the face plate 100 to position the overlay body 502 adjacent the outer perimeter 131 of the face plate 100. This configuration can be specifically beneficial when the face plate 100 includes a unique configuration such as the dial shown in FIG. 14 and the emergency call alarm shown in FIG. 15, allowing a user to removably couple the overlay body 502 on the wall surrounding the outer perimeter 131 of the face plate 100, militating against the need to configure the overlay body 502 in certain dimensions to accommodate the unique features of the face plate 100. One of ordinary skill in the art can configure the overlay 500 in any configuration within the scope of the present disclosure for coupling to the face plate 100.

The overlay 500 can be removably coupled to the face plate 100 via an adhesive, a magnet, a fastener, or any combinations thereof. The overlay body 502 can be removably coupled to the face plate 100 via an adhesive including nitrocellulose, polyvinyl acetate, ethylene copolymer, polyethylene, polyamides, polyesters, acrylics, and cyanoacrylates disposed on an underside of the overlay body 502. Alternatively, the overlay body 502 can be magnetically coupled to the face plate 100 via magnets disposed on an underside of the overlay body 502. Further, the overlay body 502 can be removably fastened to the face plate 100 via fasteners. One of ordinary skill in the art can select a suitable configuration to removably couple the overlay body 502 to the face plate 100, or the overlay body 502 to a surrounding wall adjacent the face plate 100 (as described herein).

As a non-limiting example, it should be appreciated that to calculate a contrast ratio, as described herein, one approach can involve using a single reflex lens photometer to measure the luminance of both the foreground and background colors in candelas per square meter (cd/m²). These two values can be entered into a luminance contrast calculator to automatically compute the contrast ratio. One of ordinary skill in the art can select a suitable contrast ratio calculation method within the scope of the present disclosure.

The present technology further contemplates an electrical device recognition safety system 200. The system 200 can include a face plate 100, an electrical receptacle box 101, an electrical device 103, and an overlay 500 as described herein. The electrical device 103 can be a light switch or an electrical outlet, as described herein. The overlay 500 can be configured to be removably coupled to the face plate 100 to create the first contrast 506. The overlay 500 can be configured to be removably disposed on the first portion 130a of the face plate 100 where the second portion 130b of the face plate 100 can surround the overlay body 502 as shown in FIG. 9, and the overlay body 502 can be centrally positioned on the face plate 100. The overlay 500 can be alternatively configured to be removably disposed on the first portion 130a of the face plate 100 where the overlay body 502 can surround the second portion 130b of the face plate 100, as shown in FIG. 10. The overlay body 502 can alternatively be removably disposed on an entirety of the face plate 100 as shown in FIG. 11, where the overlay body 502 can include at least two different zones to create the first contrast 506 entirely from the overlay body 502 itself. The overlay body 502 can also be removably disposed to the wall adjacent the outer perimeter 131 of the face plate 100 to create the first contrast 506 with the face plate 100, as shown in FIGS. 12-15.

The present technology can further contemplate a method of making an electrical device disposed within an electrical receptacle box safer and more easily identifiable can also be contemplated by the present technology. The method can include a step of coupling the face plate 100 to the electrical device 103. The method can include a step of coupling the overlay 500 to the face plate 100.

### EXAMPLES

Example embodiments of the present technology are provided with reference to the several figures enclosed herewith.

### Example 1—Overlay Removably Coupled to a Light Switch

With reference to FIG. 9, the overlay 500 can be configured for use with a standard electrical outlet face plate 100 including a light switch electronically coupled to a wall of a home. The overlay body 502 can be black, formed of a vinyl material having a matte finish to minimize glare and enhance color recognition. The overlay body 502 can be configured to be smaller in dimensions than dimensions of the face plate 100 to create the first contrast 506 with the face plate 100. The first contrast 506 can be a visual contrast and a textual contrast. The face plate 100 can be white and glossy while the overlay body 502 can be black and matte.

The overlay body 502 can be centrally positioned on the face plate 100 such that the second portion 130b of the face plate 100 surrounds and borders the entirety of the overlay body 502, creating the first contrast 506 between the overlay body 502 which is black and the second portion 130b of the face plate 100 which is white. The overlay body 502 can be removably coupled to the first portion 130a of the face plate 100 using an adhesive that allows for clean removal without leaving residue. A homeowner looking to turn the light on in his room can easily identify the light switch as the black matte finish of the overlay body 502 creates a striking first contrast 506 with the second portion 130b of the face plate 100. This creates a distinct visual contrast that makes the electrical outlet 103 easily identifiable in the low-light room, while maintaining the aesthetic appeal of the installation in a bedroom of the home.

### Example 2—Overlay Removably Coupled to an Electrical Receptacle

With reference to FIG. 10, the overlay 500 can be configured for use with the electrical device 103 including a standard electrical receptacle including a single receptacle positioned on a wall of a care facility. The electrical device 103 can include the face plate 100, as described herein. The overlay body 502 can be removably disposed on the first portion 130a of the face plate 100 where the overlay body 502 can be configured to surround and border the entirety of the second portion 130b of the face plate 100. The overlay body 502 can be configured in a red vinyl material with a textured surface while the face plate 100 can be configured to be white and glossy. The overlay body 502 is attached to the first portion 130a of the face plate 100 using a removable adhesive backing that includes nitrocellulose and polyvinyl acetate, allowing for repositioning during installation and clean removal when replacement is needed.

The overlay body 502 can be disposed on the first portion 130a of the face plate 100 adjacent to the outer perimeter 131, creating a border effect where the second portion 130b of the face plate 100, which is white, is completely surrounded by the red overlay body 502. This configuration creates the first contrast 506 between the overlay body 502 which is bright red and textured, and the second portion 130b of the face plate 100 which is white and glossy, making the electrical receptacle highly visible and easily identifiable, as well as identifiable to touch due to the texture. A patient at the care facility with impaired vision can easily identify the electrical receptacle by touch due to the textured surface of the overlay body 502 as well as the bright red overlay body 502, allowing the patient to plug in any desired electrical device as he desires in the care facility without the need to call a nurse for assistance. This allows the patient to be autonomous.

### Example 3—Overlay Body Covering Entire Face Plate

With reference to FIG. 11, the overlay 500 can be configured for use with the electrical device 103 including the standard electrical receptacle such as the single receptacle positioned on a wall of a classroom. The overlay body 502 can include the first zone 508 and the second zone 510, as shown in FIG. 11 where the first zone 508 can be blue and the second zone 510 can be yellow. The first zone 508 can also include designs such as polka dots, smiley faces, stripes, or any design to grab the attention of the children in the classroom. The plurality of zones 505 of the overlay body 502 can specifically be configured in colors and designs to match the classroom aesthetic for children, as well as to allow the children to easily identify the electrical receptacle. As shown in FIG. 11, the overlay body 502 completely covers the entirety of the face plate 100.

The first zone 508 can occupy approximately 50-60% of the overlay surface area, while the second zone 510 occupies 50-40%, creating a distinctive pattern between the blue and yellow colors of the first zone 508 and the second zone 510, respectively. This configuration creates the first contrast 506 entirely by the overlay body 502, militating against the need for contrast with the underlying face plate 100. The overlay body 502 is coupled to the entirety of the face plate 100 using a polyethylene terephthalate adhesive layer that provides strong adhesion while allowing for removal without damaging the underlying face plate 100 surface.

### Example 4—Overlay Body Surrounding Outer Perimeter

With reference to FIGS. 12-15, the overlay 500 can be configured for use with the electrical device 103 including the light switch, the single electrical receptacle, the double electrical receptacle, the dial, and the emergency call alarm for use in a hospital setting. The overlay body 502 can be configured to surround the entire outer perimeter 131 of the face plate 100 while leaving the entirety of the face plate 100 exposed. The overlay body 502 can be constructed from red vinyl material with a textured surface that provides tactile identification capabilities. The overlay body 502 can be configured in dimensions that are larger than dimensions of the face plate 100 for positioning the overlay body 502 adjacent the outer perimeter 131 of the face plate 100 on the wall of the hospital. This creates a 0.5-inch border of red overlay material extending beyond the outer perimeter 131 of the white face plate 100.

As shown in FIGS. 12-15, the overlay body 502 is positioned so that it extends beyond the entirety of the outer perimeter 131 of the face plate 100 on all sides, creating a prominent visual border that makes the electrical device 103 immediately noticeable. The first contrast 506 is created between the red textured overlay body 502 and the smooth white plate body 102 of the face plate 100, providing both a visual and textural contrast. The overlay body 502 is attached to the wall surface around the face plate 100 using a strong acrylic adhesive backing, ensuring that the overlay 500 remains securely in place even with repeated use of the electrical device 103. This perimeter configuration is particularly effective for marking electrical devices 103 such as the emergency call alarm visible and clearly identifiable by a patient in need, as the extended border makes the electrical device 103 visible.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An overlay for a face plate coupled to an electrical device, comprising:
an overlay body having an opening configured to provide access to the electrical device, the overlay body configured to be removably coupled to a first portion of the face plate to create a first contrast with a second portion of the face plate.

2. The overlay of claim 1, wherein the first contrast is a visual contrast.

3. The overlay of claim 2, wherein the visual contrast is created by a difference in color, a difference in lighting, and combinations thereof.

4. The overlay of claim 3, wherein the first contrast is created by a difference in color, the overlay body including a first color and the second portion of the face plate including a second color.

5. The overlay of claim 4, wherein the first color is black and the second color is white.

6. The overlay of claim 1, wherein the first contrast is a textural contrast.

7. The overlay of claim 1, wherein the overlay body is magnetically coupled to the face plate.

8. The overlay of claim 1, wherein the overlay body is coupled to the face plate via an adhesive.

9. The overlay of claim 1, wherein the overlay body is configured to be centrally disposed around an entirety of an opening of the face plate, the opening of the overlay body is aligned with the opening of the face plate to provide access to the electrical device.

10. The overlay of claim 1, wherein the second portion of the face plate is configured to surround and border an entirety of the overlay body.

11. The overlay of claim 1, wherein the overlay body is configured to surround and border an entirety of the second portion of the face plate.

12. The overlay of claim 1, wherein the overlay body is configured to be disposed adjacent an outer perimeter of the face plate.

13. An overlay for a face plate coupled to an electrical device, comprising:
an overlay body having an opening configured to provide access to the electrical device, the overlay body configured to be removably coupled to an entirety of the face plate, the overlay body configured to create a first contrast.

14. The overlay of claim 13, wherein the overlay body includes a plurality of zones including a first zone and a second zone.

15. The overlay of claim 14, wherein the first zone is configured to create the first contrast with the second zone.

16. The overlay of claim 15, wherein the first contrast of the overlay body is a visual contrast.

17. The overlay of claim 16, wherein the visual contrast is created by a difference in lighting, a difference in color, and combinations thereof.

18. The overlay of claim 17, wherein the first contrast is a textural contrast.

19. An electrical device recognition safety system, comprising:
an electrical device;
a face plate including a plate body having an opening configured to provide access to a portion of the electrical device; and
an overlay for the face plate coupled to the electrical device, the overlay including:
an overlay body having an opening configured to provide access to the electrical device, the overlay body configured to be removably coupled to one of:
a first portion of the face plate to create a first contrast with a second portion of the face plate,
an entirety of the face plate to create the first contrast, or
a wall surrounding an outer perimeter of the face plate.

20. The electrical device recognition safety system of claim 19, wherein the electrical device is a light switch or an electrical outlet.
